(19) United States
(12) Patent Application Publication
(10) Pub. No.: US 2006/0045725 A1
(43) Pub. Date: Mar. 2, 2006

(54) Device and method for stacking and transporting plates

(75) Inventor: Hans-Kurt von Werder, Langenhagen (DE)

Correspondence Address: FOLEY & LARDNER LLP, 777 EAST WISCONSIN AVENUE, SUITE 3800, MILWAUKEE, WI, 53202-5308, US

(73) Assignee: VB Autobatterie GmbH & Co. KGaA

(21) Appl. No.: 11/143,089

(22) Filed: Jun. 2, 2005

(30) Foreign Application Priority Data
Jun. 9, 2004 (DE) 10 2004 028 205.6

(51) Int. Cl. B65G 57/30

(52) U.S. Cl. 414/795.3

(57) ABSTRACT

A device for stacking and conveying battery plates includes a continuously revolving, drivable bay-type conveyor, the bay-type conveyor comprising a plurality of supports arranged vertically on a conveyor bearing surface for forming receiving bays for plate stacks. The device also includes a stacking machine provided upstream of the bay-type conveyor for forming the plate stacks received in the receiving bays of the bay-type conveyor. The device further includes a transfer apparatus provided between the stacking machine and the bay-type conveyor that is designed to transfer the plate stacks from the stacking machine, approximately horizontally, onto one of the supports of the bay-type conveyor.

### CROSS-REFERENCE TO RELATED PATENT APPLICATIONS

The present application claims the benefit of Germany Priority Application 10 2004 028 205.6, filed Jun. 9, 2004, the entire disclosure of which is hereby incorporated by reference in its entirety, including the specification, drawings, claims, and abstract.

### BACKGROUND

The present invention relates to a device for stacking and transporting battery plates. The device may include a continuously revolving, drivable bay-type conveyor, which has a multiplicity of supports, arranged vertically on the conveyor bearing surface, for forming receiving bays for plate stacks. The invention additionally relates to a method for stacking and conveying plates.

In manufacturing processes for various products, it is often necessary to form out of individual plates stacks of these plates, in which the plates lie with their flat sides one against the other and the narrow sides of the plates form a plane surface, with the result that regular cuboids are formed. Thus, in the battery industry, for example, during the manufacturing process for accumulators, there is the need to stack positive and negative electrode plates made of suitable material alternately one on top of the other and to obtain plane-sided blocks, which, in a further production step, are inserted in battery housings. For a reliable subsequent working, it has proved useful for the blocks of the positive and negative electrode plates with upright narrow plate sides to be made available for the subsequent working.

In U.S. Pat. No. 4,824,307, a device is disclosed in which individual plates or minor plate stacks are conveyed on a conveyor continuously to a site at which the plates or minor plate stacks are transferred to a second conveyor and are there further stacked. The second conveyor, also referred to as the hedgehog belt, has supports arranged perpendicular to the conveyor bearing surface, which stand in pairs at a predetermined distance apart. The transfer of the plates or minor plate stacks is effected in such a way that the second conveyor is disposed at a clear vertical distance and somewhat laterally beneath the first conveyor, and the plates or minor plate stacks drop down, under their own weight, into the bays formed by the supports arranged vertically on the second conveyor. The second conveyor is here driven at a pace such that the individual bays are filled completely with plates. The plane arrangement of the narrow plate sides is likewise achieved through the natural weight of the plates, in that the plates bang into the bays on the second conveyor at a suitably high speed and are left lying flush on the flat conveyor bearing surface. The plates can be easily destroyed by the high speed of impact, resulting in high waste. The waste and thus the production costs for the batteries rise with increasing process speed.

It would be desirable to provide an improved device and/or method for stacking and transporting battery plates.

### SUMMARY

An exemplary embodiment of the present invention relates to a device for stacking and conveying battery plates that includes a continuously revolving, drivable bay-type conveyor, the bay-type conveyor comprising a plurality of supports arranged vertically on a conveyor bearing surface for forming receiving bays for plate stacks. The device also includes a stacking machine provided upstream of the bay-type conveyor for forming the plate stacks received in the receiving bays of the bay-type conveyor. The device further includes a transfer apparatus provided between the stacking machine and the bay-type conveyor that is designed to transfer the plate stacks from the stacking machine, approximately horizontally, onto one of the supports of the bay-type conveyor.

Another exemplary embodiment of the present invention also relates to a method for stacking and transporting plates which are continuously conveyed one behind the other along a conveyor to a stacking machine. The method includes transferring the plates substantially horizontally to the stacking machine and depositing the plates, horizontally one above the other and in plane-sided stacks, in the stacking machine, to form plate stacks. The method also includes transferring the plate stacks, following the attainment of a predefined stack height, to a transfer apparatus. The method also includes transferring the plate stacks from the transfer apparatus, substantially horizontally, to a bay-type conveyor by the plate stacks being pushed, substantially horizontally, onto supports arranged vertically on a conveyor bearing surface and being carried along by the supports. The method also includes transporting the plate stacks on the bay-type conveyor in upright position, such that the side edges of the plates rest on the conveyor bearing surface.

### BRIEF DESCRIPTION OF THE DRAWINGS

The invention is described in greater detail with reference to illustrative embodiments in the appended drawings, in which:

FIG. 1 shows a diagram of a first stacking and conveying device comprising a bay-type conveyor, a stacking machine, a transfer apparatus and a conveyor according to an exemplary embodiment;

FIG. 2 shows a diagram of a top view of the stacking and conveying device from FIG. 1;

FIG. 3 shows a diagram of a second stacking and conveying device according to an exemplary embodiment; and

FIG. 4 shows a diagram of a top view of the stacking and conveying device from FIG. 3.

### DETAILED DESCRIPTION OF THE EXEMPLARY EMBODIMENTS

According to an exemplary embodiment, a device and a method is provided for stacking and transporting battery plates, having a continuously revolving, drivable bay-type conveyor, which has a multiplicity of supports, arranged vertically on the conveyor bearing surface, for forming receiving bays for plate stacks. In order to reduce damage to the plates in the formation of plate stacks, it is proposed to place upstream of the bay-type conveyor a stacking machine for forming the complete plate stacks received in the receiving bays of the bay-type conveyor, and between the stacking machine and the bay-type conveyor to provide a transfer apparatus, which is designed to transfer the plate stacks from the stacking machine, approximately horizontally, onto a support of the bay-type conveyor.

According to an exemplary embodiment, an improved device and method for stacking and transporting battery plates are provided that are intended to allow, even at high process speed, the waste rate to be reduced, the manufacturing costs lowered, and the process as a whole made more reliable as compared to existing devices and methods.

In order to solve the problems associated with existing devices and methods, the device according to an exemplary embodiment is distinguished by the fact that upstream of the bay-type conveyor there is located a stacking machine for forming the complete plate stacks received in the receiving carrier bays of the bay-type conveyor, and between the stacking machine and the bay-type conveyor there is provided a transfer apparatus, which is designed to transfer the plate stacks from the stacking machine, approximately horizontally, onto a support of the bay-type conveyor. Stacking machines of this kind, for stacking plates, are known, for example, from U.S. Pat. No. 5,431,530. A further stacking machine is known from DE 692 11 674 T 3.

The insertion of the stacking machine before the bay-type conveyor has the effect that, at constant process speed, the bay-type conveyor and the transfer apparatus can be operated at a lower speed than the conveyor on which the individual plates or minor plate stacks are transported. The lowering of the speed corresponds to the time which is required to form a complete plate stack in the stacking machine. The reduced speed both of the transfer apparatus and of the bay-type conveyor allows a slow and substantially horizontal transfer of the complete plate stacks from the transfer apparatus to the bay-type conveyor, whereby the entire process becomes more reliable and waste is reduced.

According to an exemplary embodiment, the stacking machine has a vertically movable receiving carrier for receiving plates, adjacent to the receiving carrier, a stop, against which the plate transferred from a conveyor to the stacking machine is pushed, a raising and lowering apparatus, coupled to the receiving carrier, for raising and lowering the receiving carrier, a grab in the region of the receiving carrier, adjacent to the conveyor, for receiving the plates transferred from the conveyor to the stacking machine while there is a complete plate stack present on the receiving carrier, a raising and lowering apparatus, coupled to the grab, for raising and lowering the grab, and a lift actuator, coupled to the grab, for the lateral movement, i.e. for the horizontal to-and-fro movement, of the grab, for example in the running direction of the conveyor located upstream of the stacking machine.

In one embodiment, the grab is of forked configuration. The receiving carrier has recesses in which the carriers of the grab can loosely engage.

According to an exemplary embodiment, the transfer apparatus is a belt conveyor, in which the conveyor bearing surface is formed by two belts disposed in parallel at a distance apart, the belts having a width and a spacing such that the belts can be moved in the recesses of the receiving carrier when the receiving carrier is located in a single plane with the belts.

According to a particular exemplary embodiment, the receiving carrier has two receptacles, which are disposed on one side each of the transfer apparatus and, by means of a first raising and lowering apparatus and of a second lift actuator, can be moved vertically and horizontally. The receiving carrier thus requires no further elements in the intermediate region between the receptacles, so that this intermediate region can be fully utilized to allow the grab to be led past. The interspace can be utilized for different configurations of the grab.

Advantageously, the raising and lowering apparatus for raising and lowering the receiving carrier is realized by a servo, spindle or stepping motor.

A method according to an exemplary embodiment for stacking and transporting plates which are continuously conveyed one behind the other along the conveyor to the stacking machine, including steps in which the plates are transferred, substantially horizontally, to the stacking machine, the transferred plate is stopped in its horizontal motion by the stop, the plates are deposited in the stacking machine, by cyclical lowering of the receiving carrier, horizontally one above the other and in plane-sided stacks, the plate stacks, following the attainment of a predefined stack height, are transferred to the transfer apparatus, the plate stacks are transferred from the transfer apparatus, substantially horizontally, to the bay-type conveyor by the plate stacks being pushed, substantially horizontally, onto the supports and being carried along by the supports, and the plate stacks are transported on the bay-type conveyor in upright position.

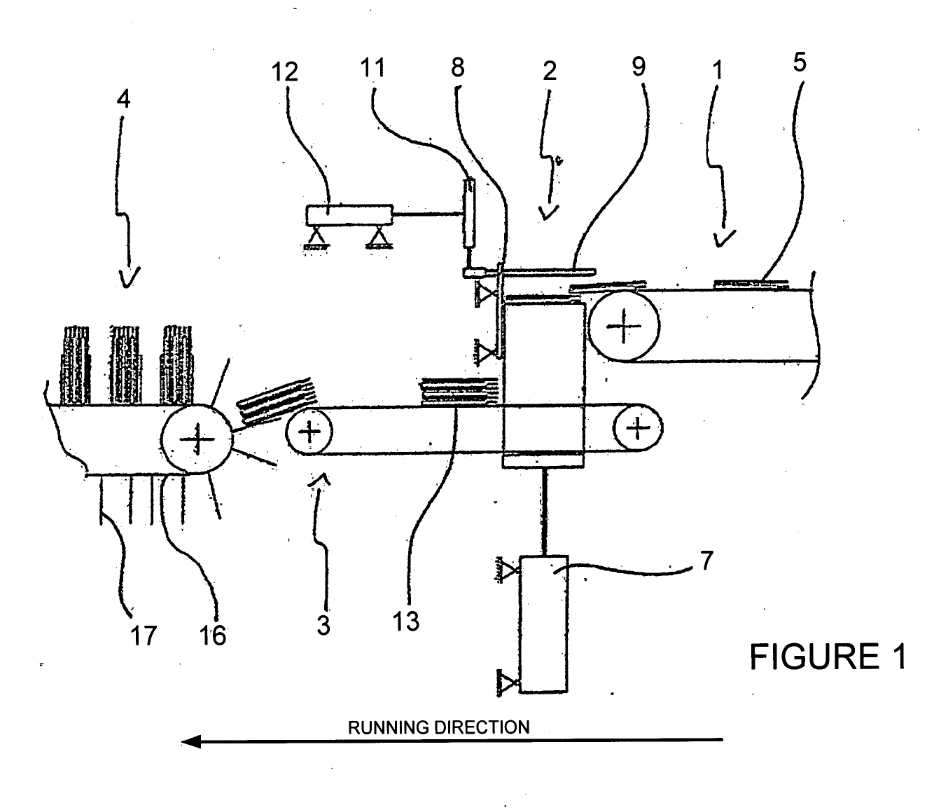

FIG. 1 shows a diagram of a stacking and conveying device comprising a conveyor 1, a stacking machine 2, a transfer apparatus 3 and a bay-type conveyor 4. The running direction of the stacking and conveying device runs from right to left.

On the continuously revolving conveyor 1, plates 5 or plate stacks are continuously transported one behind the other to the stacking machine 2. The plates 5 are disposed horizontally and expediently at a constant distance apart on the conveyor 1.

The stacking machine 2 comprises a receiving carrier 6, on which the plates 5 are deposited horizontally and one above the other in stack form, a first raising and lowering apparatus 7, situated beneath the receiving carrier 6 and coupled thereto, for raising and lowering the receiving carrier 6, a stop 8, adjacent to the receiving carrier 6 and lying opposite the conveyor 1, for stopping the transfer of the plate 5. In addition, a grab 9 having forked carriers 10 is provided on a plane parallel to the receiving plane of the receiving carrier 6. In the rest position 6, the forked carriers 10 are located above the receiving plane of the receiving carrier 6. A second raising and lowering apparatus 11 is coupled to the grab 9 in order to raise and lower the grab 9. Furthermore, a first lift actuator 12, for moving the grab 9 horizontally to and fro in the running direction of the conveyor 1 located directly upstream of the grab 9, is coupled to said conveyor.

The stacking machine 2 is disposed at the end of the conveyor 1 in such a way that the transfer of the plate 5 from the conveyor 1 to the stacking machine 2 is effected almost horizontally onto the receiving carrier 6 or onto the plates 5 already lying thereon. The stop 8 is positioned such that the plate 5, in the course of the transfer, is transported against the stop 8 and is left lying in horizontal position on the receiving carrier 6 or the plates 5. The plates 5 form in the stacking machine 2 a plate stack 13 having plane side faces. Following the transfer of a plate 5 from the conveyor 1 to the stacking machine 2, the first raising and lowering apparatus 7 lowers the receiving carrier 6, and the plates 5 located thereon, by about one plate thickness. To this end, the first raising and lowering apparatus 7 is powered by a drive mechanism, which can be a servo, spindle or stepping motor or a computer-controlled or microcomputer-controlled electric motor. A counting apparatus determines the number of plates 5 in the stacking machine 2 or the plates 5 already transported into the stacking machine 2, and hence the thickness of the plate stack 13. The grab 9 is arranged such that it can be moved by the second raising and lowering apparatus 11 and the first lift actuator 12, once the desired plate thickness is reached in the stacking machine 2, into a position to accept the next plate 5 from the conveyor 1 in the same way as the receiving carrier 6 previously.

Beneath the receiving carrier 6 there is disposed the transfer apparatus 3. The transfer apparatus 3 is a belt conveyor having two parallel belts 14. Alternatively, chains can also be used. The receiving carrier 6 is lowered by the first raising and lowering apparatus 7 to below the belts 14 of the transfer apparatus 3.

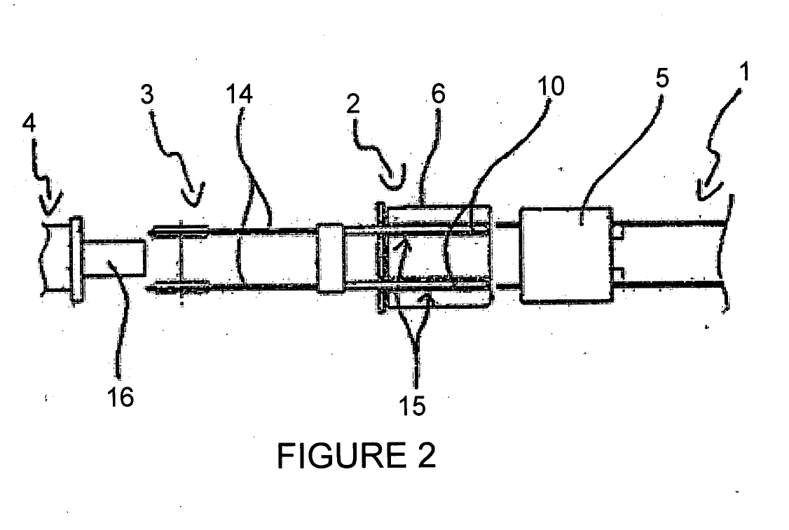

FIG. 2 illustrates that the receiving carrier 6 has, for this purpose, two forked recesses 15, having the spacing and extent of the belts 14 and in which the belts 14 can be loosely moved. As soon as the receiving carrier 6 arrives below the belts 14, the plate stack 13 is taken up by the belts 14 and carried along. The receiving carrier 6 is subsequently lifted back upward by the first raising and lowering apparatus 7 until it is able to receive the plates 5 present on the grab 9. To this end, the two parallel carriers 10 of the grab 9 are guided through the recesses 15 in the receiving carrier 6. As soon as the plates 5 have been taken over by the receiving carrier 6, the grab 9 is moved by the first lift actuator 12 horizontally out of the vertical alignment of the plates 5 in the stacking machine 2 and then, by the second raising and lowering apparatus 11 and the first lift actuator 12, into its starting position.

Located at the end of the transfer apparatus 3 is the start of the bay-type conveyor 4, having a conveyor bearing surface 16 and supports 17 projecting vertically therefrom. The bay-type conveyor 4 is arranged such that the plate stacks 13 are pushed almost horizontally onto the supports 17 and are carried along and stood upright by the supports 17. The supports 17 are arranged such that two respectively adjacent supports 17, between which there is a plate stack 13, are spaced wide apart by precisely one plate thickness in parallel position. The plate stacks 13 consequently maintain their stack shape and plane walls as they are transported in upright position by the bay-type conveyor 4.

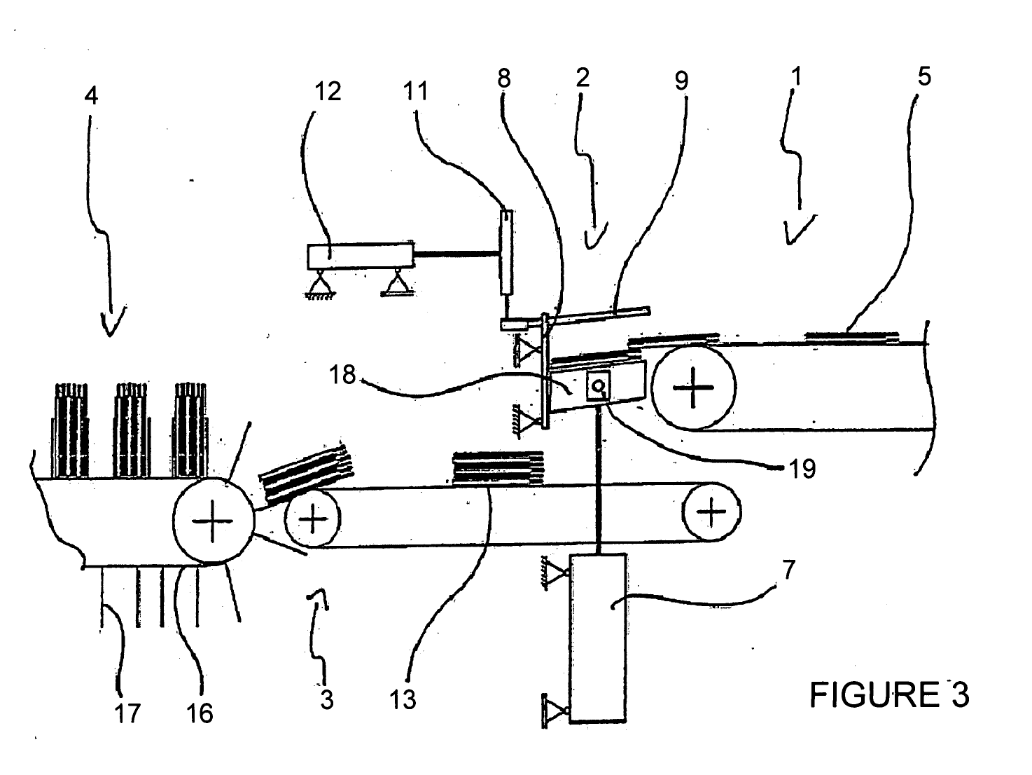

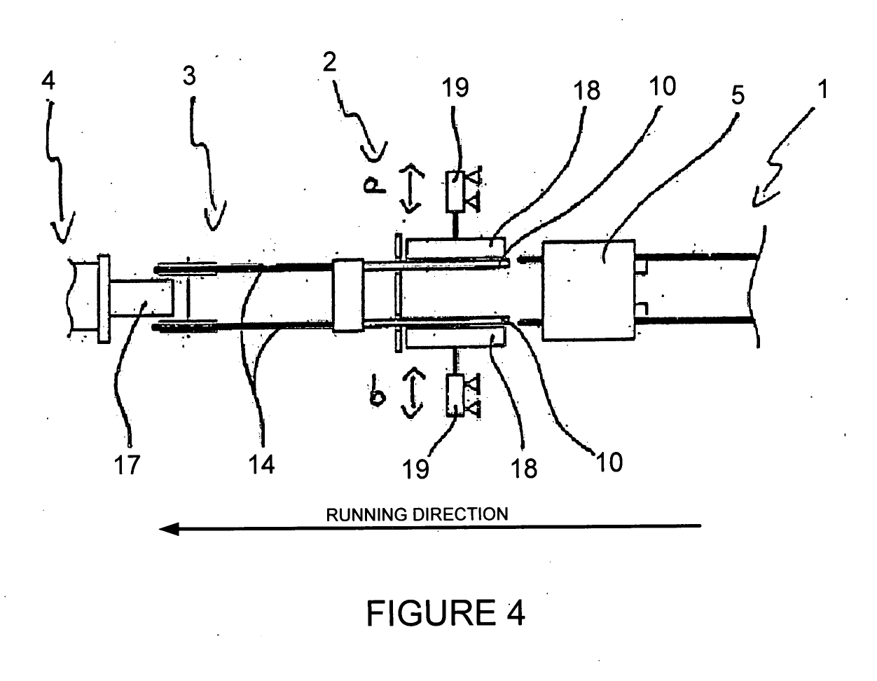

The second embodiment shown in FIGS. 3 and 4 differs from the embodiment described above in that the receiving carrier 6 consists of two rectangular receptacles 18 disposed substantially parallel to each other and to the direction of conveyance of the plates 5, which receptacles can be moved vertically by means of the first raising and lowering apparatus 7. In addition, second lift actuators 19 are provided, by which the receptacles can be moved horizontally in the direction of the double arrows a and b. By combining the first raising and lowering apparatus 7 with the second lift actuators 19, it is possible to move the receptacles 18, following the transfer of a plate stack 13 to the transfer apparatus 3, laterally in the direction of the double arrows a and b, away from the transfer apparatus 3, and thus to lead them along the side of the stacking machine 2 back into their starting position.

It is important to note that the device and method as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present inventions as expressed in the appended claims.

What is claimed is:

1. A device for stacking and conveying battery plates comprising:
a continuously revolving, drivable bay-type conveyor, the bay-type conveyor comprising a plurality of supports arranged vertically on a conveyor bearing surface for forming receiving bays for plate stacks,
a stacking machine provided upstream of the bay-type conveyor for forming the plate stacks received in the receiving bays of the bay-type conveyor, and
a transfer apparatus provided between the stacking machine and the bay-type conveyor that is designed to transfer the plate stacks from the stacking machine, approximately horizontally, onto one of the supports of the bay-type conveyor.

2. The device of claim 1 wherein the stacking machine comprises:
a receiving carrier for receiving plates,
a stop provided adjacent to the receiving carrier against which plates transferred from a conveyor to the stacking machine is transported,
a first raising and lowering apparatus coupled to the receiving carrier for raising and lowering the receiving carrier,
a grab provided proximate the receiving carrier and the conveyor for receiving the plates transferred from the conveyor to the stacking machine while there is a complete plate stack present on the receiving carrier,
a second raising and lowering apparatus coupled to the grab for raising and lowering the grab, and
a first lift actuator coupled to the grab for the horizontal movement of the grab.

3. The device of claim 2 wherein the grab is of forked configuration and the receiving carrier has recesses in which carriers of the grab can loosely engage.

4. The device of claim 2 wherein the receiving carrier has two receptacles which are disposed on one side each of the transfer apparatus and, by means of a first raising and lowering apparatus and of a second lift actuator, can be moved vertically and horizontally.

5. The device of claim 1 wherein the transfer apparatus is a conveyor having a conveyor bearing surface formed by two belts disposed in parallel at a distance apart, the belts having a width and a spacing such that the belts can be moved in the recesses of the receiving carrier when the receiving carrier is located in a single plane with the belts.

6. The device of claim 2 wherein the first raising and lowering apparatus for raising and lowering the receiving carrier comprises a servo motor.

7. The device of claim 2 wherein the first raising and lowering apparatus for raising and lowering the receiving carrier comprises a spindle motor.

8. A method for stacking and transporting plates which are continuously conveyed one behind the other along a conveyor to a stacking machine, the method comprising:
transferring the plates substantially horizontally to the stacking machine,
depositing the plates, horizontally one above the other and in plane-sided stacks, in the stacking machine, to form plate stacks;
transferring the plate stacks, following the attainment of a predefined stack height, to a transfer apparatus;
transferring the plate stacks from the transfer apparatus, substantially horizontally, to a bay-type conveyor by the plate stacks being pushed, substantially horizontally, onto supports arranged vertically on a conveyor bearing surface and being carried along by the supports; and
transporting the plate stacks on the bay-type conveyor in upright position, such that the side edges of the plates rest on the conveyor bearing surface.
